(19) United States
(12) Patent Application Publication
(10) Pub. No.: US 2009/0106544 A1
(43) Pub. Date: Apr. 23, 2009

(54) FUNCTION MANAGEMENT SYSTEM AND METHOD

(75) Inventor: Kim-Yeung Sip, Shenzhen City (CN)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/141,051

(22) Filed: Jun. 17, 2008

(30) Foreign Application Priority Data
Oct. 18, 2007 (CN) 200710202117.8

(51) Int. Cl. G06F 9/00; H04N 5/14

(52) U.S. Cl. 713/2; 348/571; 348/E05.062

(57) ABSTRACT

A function management system includes a power source, an electronic switch, a plurality of function modules, and a function management module. The power source is for supplying power. The electronic switch is for controlling the power to the function management system. The function modules are for executing various functions. The function management module is for storing a plurality of sub boot-up programs corresponding to the function modules. Each sub boot-up program is used for booting up a corresponding function module. A function management method is also provided.

### BACKGROUND

1. Field of the Invention

The present invention generally relates to a function management system and a function management method.

2. Description of Related Art

Electronic devices, such as televisions (TV), computers, etc, provide more and more functions. For example, TV's are not only useful for receiving TV programs but can be used with, for example, digital versatile disc (DVD) players, electronic games consoles, and as monitors when browsing the internet.

Referring to FIG. 5, a conventional TV 20 includes an input 21, a processor 22, a video channel 23, an audio channel 24, a DVD player 25, an electronic game module 26, a electronic switch 27, and a power source 28. The input 21 receives TV signals in Phase Alternating Line (PAL) standard, National Televisions System Committee (NTSC) standard, or Sequential Couleur Avec Memoire (SECAM) standard, and transmits the received signals to the processor 22. The processor 22 processes the TV signals to obtain compounded TV signals, and further, to separate video and audio signals from the compounded TV signals. The video channel 23 processes the video signals and transmits them to a display module (not shown) for display. The audio channel 24 process the audio signals and transmits them to a speaker (not shown) to output sound waves.

Each one of the DVD player 25 and the electronic game module 26 is an independent function module and includes a memory, a controller, a digital signal processor (DSP), and so on. When a DVD play function is activated, the power source 28 supplies power to the DVD player 25 via the electronic switch 27. The DVD player 25 reads information from an optical disc (not shown) and generates video and audio signals accordingly. The video signals and the audio signals are transmitted to the video channel 23 and the audio channel 24 respectively.

However, more functions result in management difficulty and complexity of the TV 20 and other electronic devices.

Therefore, a function management system and a function management method are needed in the industry to address the aforementioned deficiency.

### SUMMARY

A function management system includes a power source, an electronic switch, a plurality of function modules, and a function management module. The power source is for supplying power. The electronic switch is for controlling power to the function management system. The function modules are for executing various functions. The function management module is for storing a plurality of sub boot-up programs corresponding to the function modules. Each sub boot-up program is used for booting up a corresponding function module. A function management method is also provided.

Other advantages and novel features of the present invention will become more apparent from the following detailed description of preferred embodiment when taken in conjunction with the accompanying drawings.

### BRIEF DESCRIPTION OF THE DRAWINGS

FIG. 1 is a schematic block diagram showing a function management system in accordance with an exemplary embodiment, the function management system including a function management module.

FIG. 2 is a schematic block diagram showing the function management module of FIG. 1.

FIG. 3 is a schematic diagram showing a function selecting menu.

FIG. 4 is a flow chart of a function management method in accordance with an exemplary embodiment.

FIG. 5 is a schematic block diagram showing a conventional television.

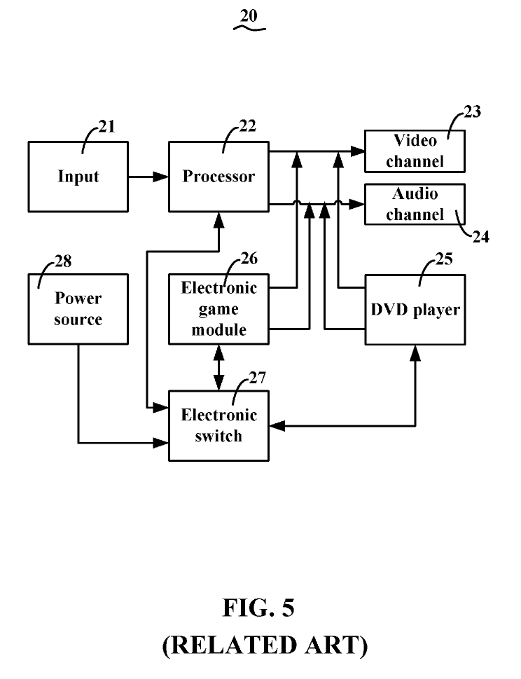

### DETAILED DESCRIPTION OF THE EMBODIMENTS

Reference will now be made to the drawings to describe an exemplary embodiment of the present function management system, and an exemplary embodiment of the present function management method.

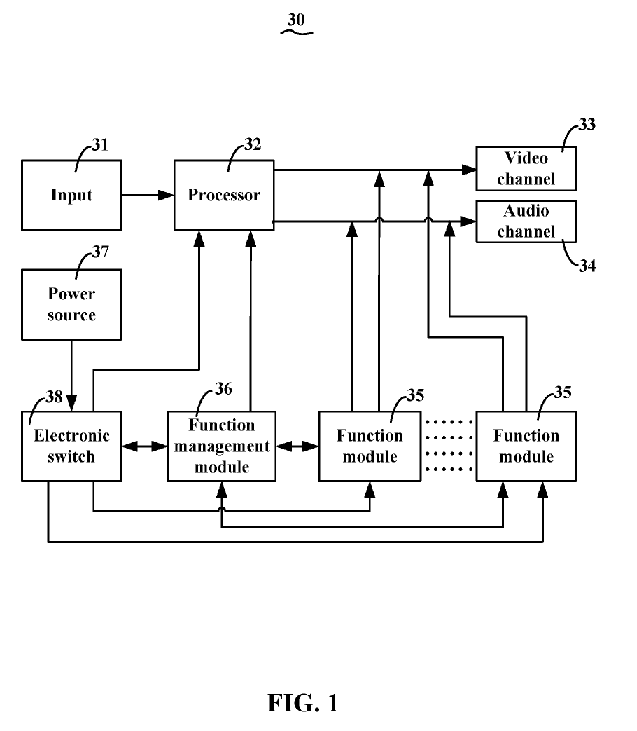

Referring to FIG. 1, a function management system 30 in accordance with an exemplary embodiment is used in a television (not shown). The function management system 30 includes an input 31, a processor 32, a video channel 33, an audio channel 34, a plurality of function modules 35, a function management module 36, a power source 37, and an electronic switch 38.

The processor 32 is connected to the input 31, the video channel 33, the audio channel 34, the function management module 36, and the electronic switch 38. The function modules 35 are connected to the video channel 33, the audio channel 34, the function management module 36, and the electronic switch 38 respectively. The function management module 36 is connected to the processor 32, the function modules 35, and the electronic switch 38. The electronic switch 38 is connected to the processor 32, the function modules 35, the function management module 36, and the power source 37.

The input 31 is used for transmitting TV signals to the processor 32. The processor 32 is used for processing the TV signals to obtain compounded TV signals and generating video and audio signals from the compounded TV signals. The function modules 35 are used for executing various functions and generating corresponding video and audio signals. Each function module 35 can independently execute a function according to a function selected command. The video channel 33 is used for processing the video signals from the processor 32 and the function modules 35 and transmitting them to a display module (not shown) for display. The audio channel 34 is used for processing the audio signals and transmitting them to a speaker (not shown) to output sound waves. The electronic switch 38 is used for transmitting power received from the power source 37 to other components. The function management module 36 is used for informing the electronic switch 38 to provide power to the function modules 35.

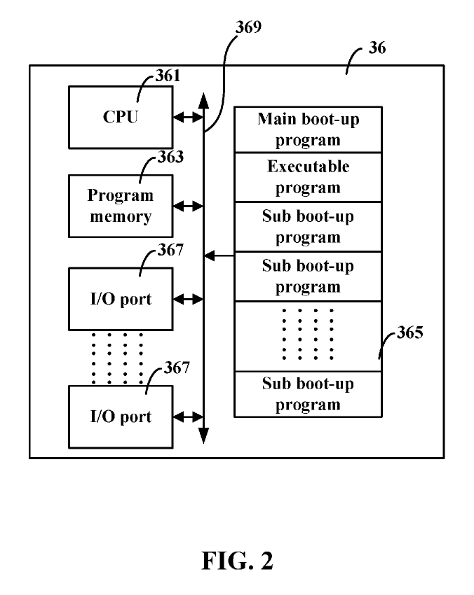

Referring to FIG. 2, the function management module 36 includes a central processing unit (CPU) 361, a program memory 363, a flash memory 365, and a plurality of I/O ports 367. A data bus 369 is used to connect the CPU 361, the program memory 363, the flash memory 365, and the I/O ports 367. Each I/O port 367 is connected to a corresponding function module 35. The program memory 363 is used for storing a main boot-up program, executable programs, and sub boot-up programs. The main boot-up program is used to boot up the function management module 36. Each sub boot-up program is used to boot-up a corresponding function module. The executable programs are used to execute ordinary operations of the television, such as allowing power to be supplied to other components, receiving TV signals, displaying videos, and so on.

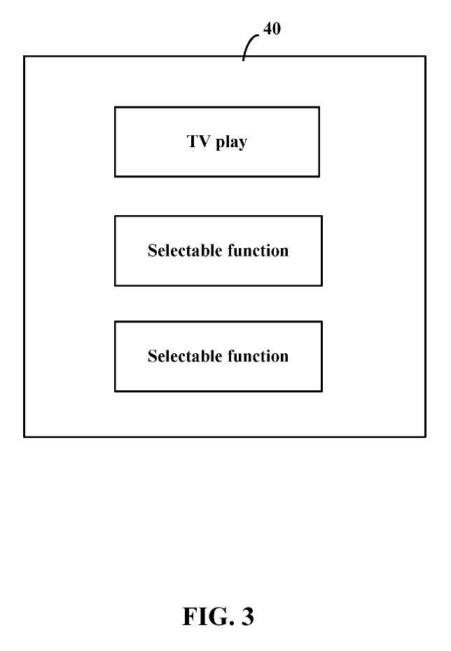

Also referring to FIG. 3, the executable programs are used to generate a function selecting menu 40. The function selecting menu 40 includes TV display as a basic function and other selectable functions corresponding to the function modules 35. If one of the selectable functions is selected, a function selected instruction is generated and received by the function management module 36.

In operation, the function management module 36 is powered up by the power source 37 via the electronic switch 38. The CPU 361 reads the main boot-up program from the flash memory 365, and then boots up the function management module 36. The executable programs are transferred to the program memory 363 via the bus 369, and the function selecting menu 40 is generated. When one selectable function in the function selecting menu 40 is selected, the CPU 361 receives a corresponding function selected instruction. The CPU 361 reads a sub boot-up program from the flash memory 365 corresponding to the function selected instruction. The CPU 361 identifies whether other function modules 35, except for a selected function module 35, corresponding to the sub boot-up program are currently active. If one of the other function modules 35 is currently active, the CPU 361 sends a command to stop the one of the function modules 35. If none of the other function modules 35 is currently active, the sub boot-up program is executed, thus the selected function module 35 is booted up based on the sub boot-up program and executes a corresponding function.

As mentioned above, the function management system 30 uses a function management module 36 to store the main boot-up program and the sub boot-up programs. Therefore, irrespective of the number of function modules 35, the sub boot-up programs are managed uniformly in the function management module 36.

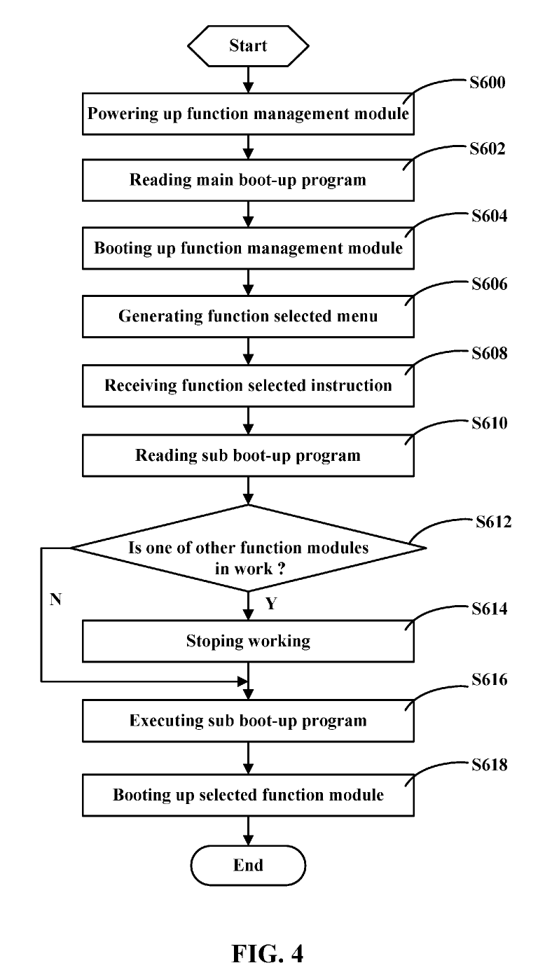

Referring to FIG. 4, a flow chart showing a procedure of the function management method for controlling the function modules 35 of the function management system 30 is illustrated. The procedure includes the following steps.

In step S600, the function management module 36 is powered up.

In step S602, the CPU 361 reads a main boot-up program.

In step S604, the function management module 36 is booted up.

In step S606, a function selecting menu 40 is generated based on an executable program.

In step S608, one selectable function in the function selecting menu 40 is selected, and the CPU 361 receives a corresponding function selected instruction.

In step S610, a sub boot-up program corresponding to the function selected instruction is read.

In step S612, the CPU 361 identifies whether other function modules except for a selected function module corresponding to the sub boot-up program are currently active. If one of the other function modules 34 is currently active, the procedure goes to step S614. If none of the other function modules is currently active, the procedure goes to step S616.

In step S614, the one function module is ordered to stop.

In step S616, the sub boot-up program is executed.

In step S618, the selected function module is booted up based on the sub boot-up program.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A function management system comprising:
a power source for supplying power;
an electronic switch for controlling the power to the function management system;
a plurality of function modules for executing various functions; and
a function management module for storing a plurality of sub boot-up programs for booting up the corresponding function modules.

2. The function management system according to claim 1, wherein the function management module comprises a flash memory for storing a main boot-up programs for booting up the function management module, the sub boot-up programs, and an executable program for generating a function selecting menu.

3. The function management system according to claim 2, wherein the function management module comprises a central processing unit for reading the main boot-up program, the sub boot-up program, and the executable program, and receiving a function selected instruction.

4. The function management system according to claim 3, wherein the function management module comprises a program memory for receiving the executable program from the flash memory.

5. The function management system according to claim 4, wherein the function management module comprises a plurality of I/O ports connected to the function modules respectively.

6. The function management system according to claim 5, wherein the function management module comprises a data bus connecting the central processing unit, the program memory, the flash memory, and the I/O ports.

7. The function management system according to claim 1, further comprising an input for receiving television signals.

8. The function management system according to claim 7, further comprising a processor for processing the television signals to generate video and audio signals.

9. The function management system according to claim 8, further comprising a video channel for processing the video signals from the processor and then outputting the video signals.

10. The function management system according to claim 8, further comprising an audio channel for processing the audio signals from the processor and then outputting the audio signals.

11. A function management method comprising:
receiving a function selected instruction;
reading a sub boot-up program corresponding to the function selected instruction;
identifying whether other function modules except for a selected function module corresponding to the sub boot-up program are currently active;
transmitting the sub boot-up program to the selected function module if none of the other function modules is currently active; and
booting up the selected function module.

12. The function management method according to claim 11, further comprising:
ordering one function module to stop if the one function module is currently active.

13. The function management method according to claim 11, further comprising:
powering up a function management module.

14. The function management method according to claim 13, further comprising:
reading a main boot-up program;
booting up the function management module.

15. The function management method according to claim 14, further comprising:
generating a function selecting menu;
selecting one selectable function of the function selecting menu.
